(19) United States
(12) Patent Application Publication
(10) Pub. No.: US 2014/0028503 A1
(43) Pub. Date: Jan. 30, 2014

(54) MULTIBAND ANTENNA

(71) Applicant: ASKEY COMPUTER CORP., NEW TAIPEI CITY (TW)

(72) Inventors: CHIH-CHENG CHIEN, DAXI TOWNSHIP (TW); CHIN-HSU LAI, NEW TAIPEI CITY (TW)

(73) Assignee: ASKEY COMPUTER CORP., NEW TAIPEI CITY (TW)

(21) Appl. No.: 13/673,139

(22) Filed: Nov. 9, 2012

(30) Foreign Application Priority Data
Jul. 27, 2012 (TW) 101127175

(51) Int. Cl. H01Q 5/01

(52) U.S. Cl. 343/700 MS

(57) ABSTRACT

A multiband antenna for an electronic device includes a resonance radiation body, a grounding end, and a spread spectrum portion. The resonance radiation body receives a first electromagnetic wave signal at a first frequency (known as fundamental frequency). The grounding end and the electronic device are connected. The spread spectrum portion is disposed between the resonance radiation body and the grounding end. The spread spectrum portion includes first and second shunting bodies to form a loop bypass between the resonance radiation body and the grounding end and thereby decrease and increase the first frequency by a specific frequency value so as to define a bandwidth equal to two times the specific frequency value. Hence, the electronic device receives a second electromagnetic wave signal at any frequency within the bandwidth. Since the spread spectrum portion defines the bandwidth, the electronic device can receive the first and second electromagnetic wave signals.

### CROSS-REFERENCE TO RELATED APPLICATION

This non-provisional application claims priority under 35 U.S.C. §119(a) on Patent Application No(s). 101127175 filed in Taiwan, R.O.C. on Jul. 27, 2012, the entire contents of which are hereby incorporated by reference.

### FIELD OF TECHNOLOGY

The present invention relates to multiband antennas, and more particularly, to a multiband antenna capable of receiving an electromagnetic wave signal at a fundamental frequency and an electromagnetic wave signal at any frequency within a bandwidth defined with lower and upper frequency limits obtained by decreasing and increasing the fundamental frequency by a specific frequency value, respectively.

### BACKGROUND

At present, wireless communication-oriented electronic devices are in wide use, such that the distance between human beings has never been shorter than it is today. To this end, the key technology of the wireless communication-oriented electronic devices lies in transmitting and receiving an electromagnetic wave signal with an antenna.

However, the operating frequency or bandwidth of the wireless communication-oriented electronic devices varies from wireless communication protocol to wireless communication protocol. For instance, the mobile communication protocol (that is, the aforesaid wireless communication protocol) of the Global System for Mobile Communications (GSM) requires the frequencies of applicable electromagnetic wave signals to be 850 MHz, 900 MHz, 1800 MHz or 1900 MHz. Furthermore, the GSM is not as globalized as its name implies, because GSM systems operate at different operating frequencies (or known as fundamental frequencies as referred to hereunder.)

Assuming that a single electronic product has to comply with multiple communication protocols, it will be necessary for the electronic product to have multiple built-in antennas in order for the electronic product to operate in a multi-frequency environment. Furthermore, although it is possible for the electronic devices to accommodate the antennas concurrently, electromagnetic interference between the antennas results in deterioration of communication quality.

Accordingly, it is imperative to optimize the application of a multiband antenna by eliminating the electromagnetic interference which might otherwise occur between multiple antennas built in an electronic device for complying with different wireless communication protocols.

### SUMMARY

It is an objective of the present invention to provide a multiband antenna capable of receiving an electromagnetic wave signal at a fundamental frequency and/or an electromagnetic wave signal at any frequency within a bandwidth defined with lower and upper frequency limits obtained by decreasing and increasing the fundamental frequency by a specific frequency value, respectively.

Another objective of the present invention is to provide the aforesaid multiband antenna adapted to be supplied with a loop surface current so as to enable the electronic device, which is previously restricted to receiving an electromagnetic wave signal at a single fundamental frequency, to be able to receiving electromagnetic wave signals at a plurality of frequencies within the aforesaid bandwidth as well.

In order to achieve the above and other objectives, the present invention provides a multiband antenna for use with an electronic device having a signal end and a common ground end. The multiband antenna comprises a resonance radiation body, a grounding end, and a spread spectrum portion. The resonance radiation body is connected to the signal end of the electronic device and receives a first electromagnetic wave signal at a first frequency. The grounding end is connected to the common ground end of the electronic device. The spread spectrum portion connects the resonance radiation body and the grounding end, has a first shunting body and a second shunting body, forms an opening between the resonance radiation body and the grounding end by means of the first shunting body and the second shunting body, thereby allowing the first shunting body and the second shunting body to form a loop bypass between the resonance radiation body and the grounding end.

Accordingly, a multiband antenna of the present invention comprises the spread spectrum portion of a plurality of shunting bodies for expanding the range of frequencies applicable to the resonance radiation body, for example, expanding the frequency applicability from a single frequency to a plurality of frequencies. The resonance radiation body increases the overall loop surface current of the multiband antenna by means of the shunting bodies to thereby enable the multiband antenna of the present invention to receive electromagnetic wave signals at multiple frequencies within a bandwidth rather than at a single frequency.

With the multiple frequencies forming a continuum, the multiple frequencies together form a bandwidth, such that the multiband antenna not only receives a first electromagnetic wave signal at the first frequency but also receives a second electromagnetic wave signal at any frequency within the bandwidth. Hence, the second electromagnetic wave signal is defined as an electromagnetic wave signal at any frequency within the bandwidth.

Accordingly, the present invention provides a multiband antenna for use with the electronic device to thereby enable the electronic device to operate at multiple frequencies without any additional resonance radiation body. Furthermore, the present invention enhances the radiation efficiency of the conventional resonance radiation bodies.

### BRIEF DESCRIPTION OF THE DRAWINGS

Objectives, features, and advantages of the present invention are hereunder illustrated with specific embodiments in conjunction with the accompanying drawings, in which:

FIGS. 1a-1b are structural schematic views of a multiband antenna according to the first embodiment of the present invention;

FIGS. 2a-2b are structural schematic views of a multiband antenna according to the second embodiment of the present invention;

FIG. 3 is a structural schematic view of a multiband antenna according to the third embodiment of the present invention; and

FIGS. 4a-4b are characteristic curves plotted by an actual test performed on the multiband antenna in FIG. 3.

### DETAILED DESCRIPTION

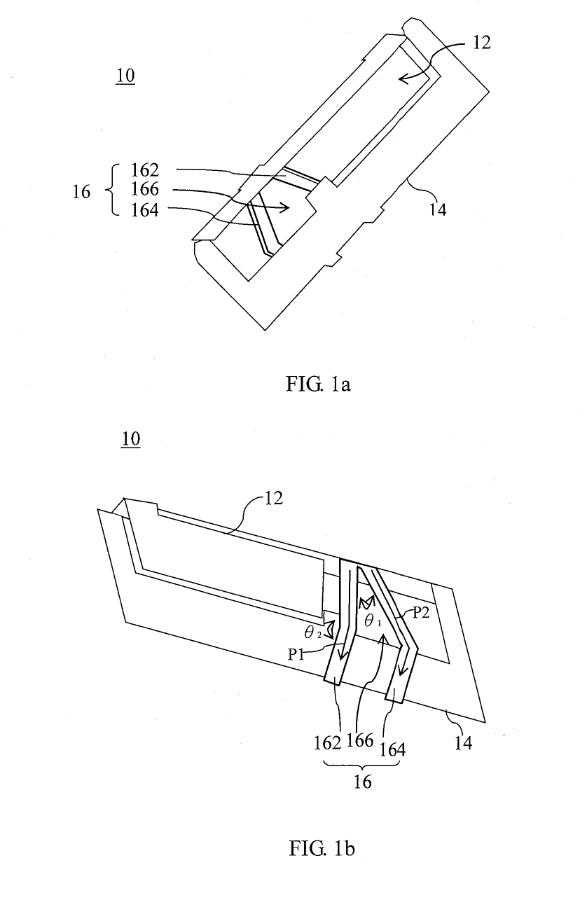

Referring to FIGS. 1a-1b, there are shown structural schematic views of a multiband antenna according to the first embodiment of the present invention. FIG. 1a is a front view of the multiband antenna, whereas FIG. 1b is a rear view of the multiband antenna. As shown in FIGS. 1a-1b, the multiband antenna 10 is for use with an electronic device (not shown), such that the electronic device operates by means of the multiband antenna 10 under a wireless communication protocol of 2G, 2.5G, 3G, 3.5G, 4G or WiFi. In general, the multiband antenna 10 is connected to a communication module (not shown) of the electronic device. The communication module comprises a signal end and a common ground end. The signal end receives or transmits an electromagnetic wave signal. The common ground end and the signal end together form an electrical loop whereby the electromagnetic wave signal is transmitted between the electronic device and the multiband antenna 10.

The multiband antenna 10 enables the electronic device to not only receive a first electromagnetic wave signal at a first frequency but also receive a second electromagnetic wave signal at any frequency within a bandwidth defined with lower and upper frequency limits obtained by decreasing and increasing the first frequency by a specific frequency value, respectively. For example, the first frequency is 850 MHz (MHz), 900 MHz, 1800 MHz, 1900 MHz, or 2100 MHz. A way of decreasing and increasing the first frequency by a specific frequency value to thereby define the aforesaid bandwidth is described below.

Given the first frequency of 900 MHz and a specific frequency value of 50 MHz, the range of frequency, that is, the bandwidth, applicable to the multiband antenna 10 starts from 850 MHz (because 900 MHz minus 50 MHz is 850 MHz) and ends at 950 MHz (because 900 MHz plus 50 MHz is 950 MHz).

Hence, the multiband antenna 10 enables the electronic device to not only receive the first electromagnetic wave signal at the first frequency of 900 MHz but also receive the second electromagnetic wave signal at a frequency between 850 MHz and 950 MHz.

The multiband antenna 10 comprises a resonance radiation body 12, a grounding end 14, and a spread spectrum portion 16.

Referring to FIG. 1a, the resonance radiation body 12 enables the electronic device to receive the first electromagnetic wave signal at the first frequency. The first frequency depends on the dimensions and shape of the resonance radiation body 12. In this embodiment, the resonance radiation body 12 is sheet-shaped to serve an illustrative purpose.

For example, the resonance radiation body 12 receives the first electromagnetic wave signal in a manner that the first electromagnetic wave signal thus received can effectively stay on the resonance radiation body 12. Hence, in this embodiment, the resonance radiation body 12 is of a length equal to one-fourth of a wavelength associated with the first frequency.

The mathematic expression of the relationship between frequency and wavelength is as follows

λ=C/f;

where wavelength (m) is denoted by λ, frequency (s⁻¹ or Hz) by f, and speed of light (ms⁻¹) by c, wherein speed of light is a constant equal to 3×10⁸ ms⁻¹.

For example, given the first frequency of 850 MHz, one-fourth of a wavelength associated with the first frequency is equal to 0.088 m, and thus the resonance radiation body 12 is preferably 0.088 m long in order to function well. For example, given the first frequency of 900 MHz, one-fourth of a wavelength associated with the first frequency is equal to 0.0833 m, and thus the resonance radiation body 12 is preferably 0.0833 m long in order to function well. For example, given the first frequency of 1800 MHz, one-fourth of a wavelength associated with the first frequency is equal to 0.042 m, and thus the resonance radiation body 12 is preferably 0.042 m long in order to function well. For example, given the first frequency of 1900 MHz, one-fourth of a wavelength associated with the first frequency is equal to 0.039 m, and thus the resonance radiation body 12 is preferably 0.039 m long in order to function well. For example, given the first frequency of 2100 MHz, one-fourth of a wavelength associated with the first frequency is equal to 0.036 m, and thus the resonance radiation body 12 is preferably 0.036 m long in order to function well.

The grounding end 14 is connected to the common ground end (not shown) of the electronic device. Once the grounding end 14 and the common ground end get connected together, the voltage level at the grounding end 14 will equal the voltage level at the common ground end.

Referring to FIG. 1b, the spread spectrum portion 16 is disposed between the resonance radiation body 12 and the grounding end 14. The purpose of the spread spectrum portion 16 is to define a frequency range, that is, a bandwidth, defined by lower and upper frequency limits obtained by decreasing and increasing the first frequency by a specific frequency value, respectively, such that the electronic device receives, by means the spread spectrum portion 16, a second electromagnetic wave signal at any frequency within the bandwidth. A first shunting body 162 and a second shunting body 164 of the spread spectrum portion 16 together form an opening 166 between the resonance radiation body 12 and the grounding end 14. The first shunting body 162 and the second shunting body 164 form loop bypasses P1, P2, respectively, between the resonance radiation body 12 and the grounding end 14. The spread spectrum portion 16 performs frequency spreading on the first frequency by means of the loop bypasses P1, P2. In this embodiment, the loop bypasses P1, P2 enable the resonance radiation body 12 of the multiband antenna of the present invention to gain access to more electric current than a conventional antenna devoid of the spread spectrum portion 16 of the present invention does.

Hence, due to the spread spectrum portion 16, a bandwidth defined and applied to the resonance radiation body 14 is based on and associated with the first frequency.

Furthermore, the first shunting body 162 and the second shunting body 164 of the spread spectrum portion 16 are arranged in an inverted V-shaped configuration between the resonance radiation body 12 and the grounding end 14. In this embodiment, one end of the first shunting body 162 joins one end of the second shunting body 164 at a point of one side (for example, a longer side) of the resonance radiation body 12. A first included angle θ₁ is formed at the joint between the first shunting body 162 and the second shunting body 164.

The other end of the first shunting body 162 and the other end of the second shunting body 164 are directly connected to one side of the grounding end. This embodiment is exemplified by the scenario where the other end of the first shunting body 162 and the other end of the second shunting body 164 are perpendicularly connected to the grounding end 14.

From a perspective different from the preceding one, the first shunting body 162 and the second shunting body 164 extend from the joint characterized by the first included angle θ₁ toward the grounding end 14 and then each bend by a second included angle θ₂ before reaching the grounding end 14.

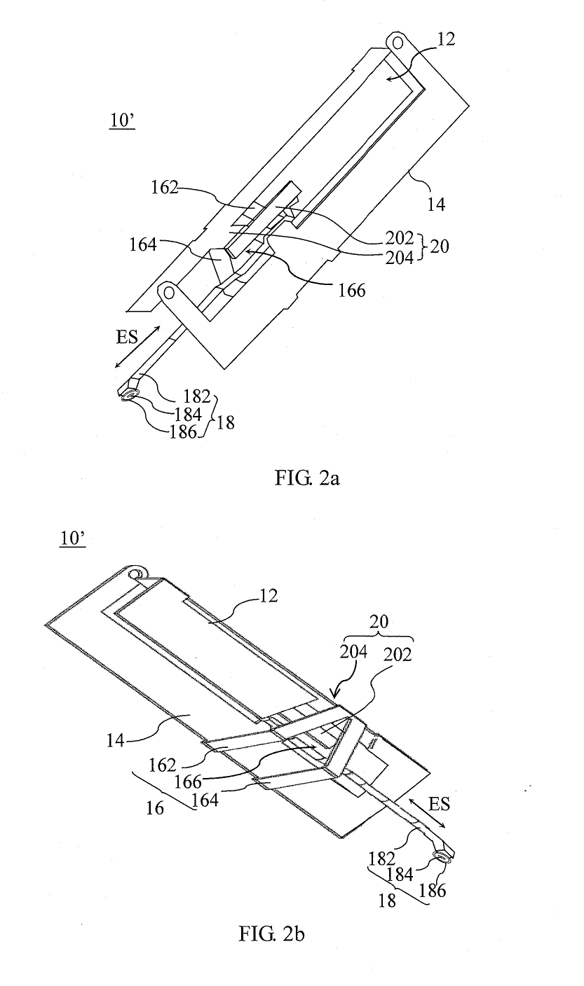

Referring to FIGS. 2a-2b, there are shown structural schematic views of a multiband antenna 10′ according to the second embodiment of the present invention. FIG. 2a is a perspective view of the multiband antenna 10′, whereas FIG. 2b is a perspective view of the multiband antenna 10′ taken from a view angle different from that of FIG. 2a. As shown in FIGS. 2a-2b, the multiband antenna 10′, which is applicable to an electronic device (not shown), not only includes the resonance radiation body 12, the grounding end 14, and the spread spectrum portion 16 described in the first embodiment, but also includes a feed-in portion 18 and a connection portion 20. The feed-in portion 18 and the connection portion 20 are disposed between the resonance radiation body 12 and the electronic device.

The feed-in portion 18 has one end connected to a communication module of the electronic device, such that an electronic signal (ES) is transmitted between the multiband antenna 10′ and the electronic device via the feed-in portion 18. In this embodiment, the feed-in portion 18 is exemplified by a conventional high-frequency coaxial cable. The conventional high-frequency coaxial cable 18 comprises a central axial portion 182, an intermediate high-frequency signal line 184, and a peripheral ground wire 186. Conventional high-frequency coaxial cables are well known among persons skilled in the art, and thus structural details of conventional high-frequency coaxial cables are not described herein for the sake of brevity.

The connection portion 20 connects the feed-in portion 18 and the resonance radiation body 12. In this embodiment, the connection portion 20 comprises a first connecting plate 202 and a second connecting plate 204, and the connection portion 20 is sheet-shaped.

The connection portion 20 is connected to the feed-in portion 18 via the first connecting plate 202 and to the resonance radiation body 12 via the second connecting plate 204. Furthermore, the first connecting plate 202 and the second connecting plate 204 of the connection portion 20 are arranged in a manner to allow the connection portion 20 to assume an L-shaped appearance. The length of the connection portion 20 equals one-eighth of the wavelength associated with the first frequency.

For example, given the first frequency of 850 MHz, one-eighth of a wavelength associated with the first frequency is equal to 0.441 m, and thus the connection portion 20 is preferably 0.441 m long in order to function well. For example, given the first frequency of 900 MHz, one-eighth of a wavelength associated with the first frequency is equal to 0.417 m, and thus the connection portion 20 is preferably 0.417 m long in order to function well. For example, given the first frequency of 1800 MHz, one-eighth of a wavelength associated with the first frequency is equal to 0.208 m, and thus the connection portion 20 is preferably 0.208 m long in order to function well. For example, given the first frequency of 1900 MHz, one-eighth of a wavelength associated with the first frequency is equal to 0.197 m, and thus the connection portion 20 is preferably 0.197 m long in order to function well. For example, given the first frequency of 2100 MHz, one-eighth of a wavelength associated with the first frequency is equal to 0.179 m, and thus the connection portion 20 is preferably 0.179 m long in order to function well.

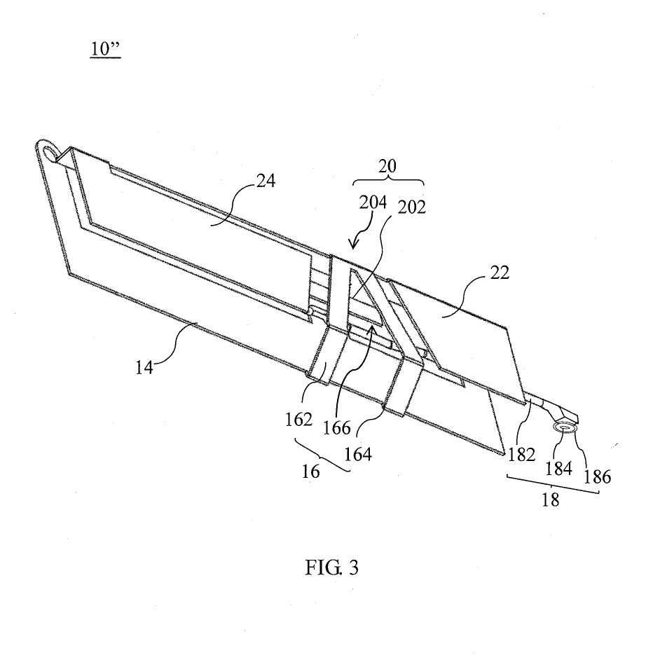

Referring to FIG. 3, there is shown a structural schematic view of a multiband antenna 10″ according to the third embodiment of the present invention. As shown in FIG. 3, the multiband antenna 10″ is applicable to the electronic device. In this embodiment, a plurality of resonance radiation bodies 22, 24 enables the electronic device to receive the first electromagnetic wave signals at a plurality of first frequency (such as 900 MHz and 1900 MHz), whereas the spread spectrum portion 16 enables the electronic device to receive the second electromagnetic wave signal at any frequency within a bandwidth defined with lower and upper frequency limits obtained by decreasing and increasing the first frequency by a specific frequency value, respectively. For example, the electronic device operating in conjunction with the multiband antenna 10″ is capable of receiving electromagnetic wave signals at 850 MHz, 900 MHz, 1800 MHz, 1900 MHz, and 2100 MHz concurrently according to related mobile communication protocols.

The multiband antenna 10″ not only includes the grounding end 14, the spread spectrum portion 16, the feed-in portion 18 and the connection portion 20 described in the first embodiment, but also includes the resonance radiation bodies 22, 24.

The resonance radiation bodies 22, 24 are connected to the second connecting plate 204 of the connection portion 20. The resonance radiation bodies 22, 24 are designed to come in the form of a plurality of radiating plates based on and thus related to the first frequencies. In this embodiment, the resonance radiation bodies 22, 24 are further defined as the low-frequency resonance radiation body 22 (operating at 900 MHz, for example) and the high-frequency resonance radiation body 24 (operating at 1900 MHz, for example) in accordance with the quarter-wavelength rule.

It is feasible that the low-frequency resonance radiation body 22 and the high-frequency resonance radiation body 24 of the multiband antenna 10″ are applicable to different bandwidths concurrently by means of the connection portion 20 and the spread spectrum portion 16. For example, the low-frequency resonance radiation body 22 of the multiband antenna 10″ is applicable to a bandwidth of 850 MHz through 950 MHz when operating in conjunction with the low-frequency resonance radiation body 22, the connection portion 20, and the spread spectrum portion 16, but is only applicable to a single frequency of 900 MHz when operating in conjunction with the low-frequency resonance radiation body 22 but in the absence of the connection portion 20 and the spread spectrum portion 16 as taught by the prior art. Similarly, the high-frequency resonance radiation body 24 of the multiband antenna 10″ is applicable to a bandwidth of 1800 MHz through 2100 MHz when operating in conjunction with the high-frequency resonance radiation body 24, the connection portion 20, and the spread spectrum portion 16, but is only applicable to a single frequency of 1900 MHz when operating in conjunction with the high-frequency resonance radiation body 24 but in the absence of the connection portion 20 and the spread spectrum portion 16 as taught by the prior art.

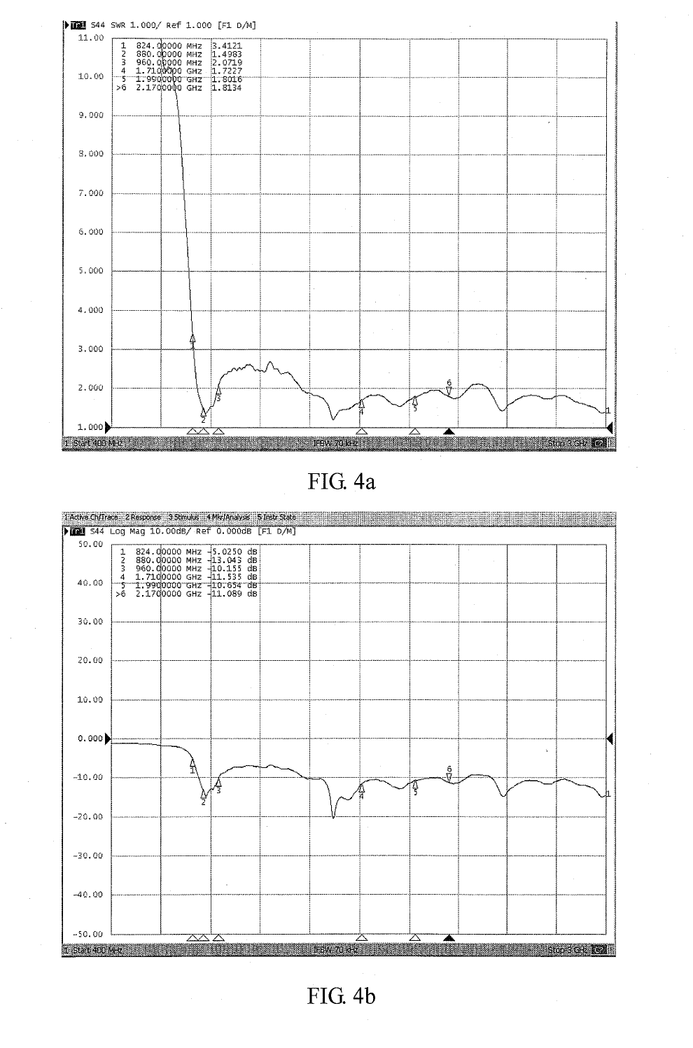

Referring to FIGS. 4a-4b, there are shown characteristic curves plotted by an actual test performed on the multiband antenna in FIG. 3.

Referring to FIG. 4a, the curve indicates the voltage standing wave ratio (VSWR) of the multiband antenna 10″. When a transmission line (cable) is terminated by an impedance that does not match the characteristic impedance of the transmission line, not all of the power is absorbed by the termination. Part of the power is reflected back toward the source end of the transmission line. The forward (or incident) signal mixes with the reverse (or reflected) signal to cause a voltage standing wave pattern on the transmission line. The ratio of the maximum to minimum voltage is known as VSWR, or Voltage Standing Wave Ratio.

An ideal transmission line would have a VSWR of 1:1, with all the power reaching the destination and there is no power being reflected back to the source.

The multiband antenna 10″ of the present invention allows the electronic device to have a VSWR of 3.4121:1 at the first frequency of 824 MHz, a VSWR of 1.4983:1 at the first frequency of 880 MHz, a VSWR of 2.0719:1 at the first frequency of 960 MHz, a VSWR of 1.7227:1 at the first frequency of 1710 MHz, a VSWR of 1.8016:1 at the first frequency of 1990 MHz, and a VSWR of 1.8134:1 at the first frequency of 2170 MHz. Hence, the aforesaid data indicates that the VSWR of the multiband antenna 10″ of the present invention approximates to the 1:1 VSWR of an ideal antenna.

Referring to FIG. 4b, the curve indicates the antenna return loss of the multiband antenna 10″. For example, the curve indicates an antenna return loss of −5.025 dB of the multiband antenna 10″ operating at the first frequency of 824 MHz, an antenna return loss of −13.043 dB of the multiband antenna 10″ operating at the first frequency of 880 MHz, an antenna return loss of −10.155 dB of the multiband antenna 10″ operating at the first frequency of 960 MHz, an antenna return loss of −11.535 dB of the multiband antenna 10″ operating at the first frequency of 1710 MHz, an antenna return loss of −10.654 dB of the multiband antenna 10″ operating at the first frequency of 1990 MHz, an antenna return loss of −11.089 dB of the multiband antenna 10″ operating at the first frequency of 2170 MHz. Persons skilled in the art understand that an ideal antenna would have an antenna return loss of less than −5.0 dB.

Referring to Table 1 below, there is shown a table of antenna gains of the multiband antenna 10′.

TABLE 1

| | X-Y Plane | | Y-Z Plane | | X-Z Plane | |
|---|---|---|---|---|---|---|
| Freq. | | Average | | Average | | Average |
| (MHz) | Peak Gain | Gain | Peak Gain | Gain | Peak Gain | Gain |
| 824.2 | −2.91 | −5.35 | −0.53 | −3.84 | −1.67 | −4.25 |
| 848.8 | −1.70 | −4.66 | 0.05 | −3.30 | 0.04 | −3.01 |
| 880.2 | −1.34 | −4.45 | 0.80 | −2.95 | 0.77 | −2.39 |
| 893.8 | −1.33 | −4.44 | 0.98 | −2.87 | 1.09 | −2.28 |
| 914.8 | −1.05 | −4.25 | 1.20 | −2.78 | 1.56 | −2.06 |
| 959.8 | −2.34 | −5.17 | 0.30 | −3.56 | 0.95 | −2.79 |
| 1710.2 | −0.23 | −3.29 | −1.14 | −2.78 | −0.96 | −3.36 |
| 1784.8 | −1.02 | −4.01 | −0.11 | −2.92 | −0.75 | −4.86 |
| 1850.2 | −0.93 | −3.76 | 0.73 | −2.70 | −1.25 | −5.56 |
| 1879.8 | −0.58 | −3.58 | 0.75 | −2.63 | −1.47 | −5.63 |
| 1909.8 | −0.55 | −3.63 | 1.00 | −2.55 | −1.49 | −5.57 |
| 1922.4 | −0.51 | −3.71 | 0.84 | −2.66 | −1.49 | −5.62 |
| 1977.6 | −0.19 | −3.31 | 1.00 | −2.28 | −1.37 | −5.13 |
| 1989.8 | −0.60 | −3.51 | 0.82 | −2.49 | −1.42 | −5.22 |
| 2167.6 | −0.38 | −3.79 | 1.29 | −2.20 | −0.64 | −5.29 |

For example, Table 1 indicates the following: given the first frequency of 914.8 MHz, there are a peak gain of −1.05 dBi and an average gain of −4.25 dBi in the X-Y plane, a peak gain of 1.20 dBi and an average gain of −2.78 dBi in the Y-Z plane, and a peak gain of 1.56 dBi and an average gain of −2.06 dBi in the X-Z plane; and, given the first frequency of 1850.2 MHz, there are a peak gain of −0.93 dBi and an average gain of −3.76 dBi in the X-Y plane, a peak gain of 0.73dBi and an average gain of −2.70 dBi in the Y-Z plane, and a peak gain of −1.25 dBi and an average gain of −5.56 dBi in the X-Z plane. On the whole, the antenna gain achieved by the present invention is satisfactory.

Accordingly, a multiband antenna of the present invention comprises the spread spectrum portion of a plurality of shunting bodies for expanding the range of frequencies applicable to the resonance radiation body, for example, expanding the frequency applicability from a single frequency to a plurality of frequencies. The resonance radiation body increases the overall loop surface current of the multiband antenna by means of the shunting bodies to thereby enable the multiband antenna of the present invention to receive electromagnetic wave signals at multiple frequencies within a bandwidth rather than at a single frequency.

Accordingly, the present invention provides a multiband antenna for use with the electronic device to thereby enable the electronic device to operate at multiple frequencies without any additional resonance radiation body. Furthermore, the present invention enhances the radiation efficiency of the conventional resonance radiation bodies.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A multiband antenna for use with an electronic device having a signal end and a common ground end, the multiband antenna comprising:
a resonance radiation body connected to the signal end of the electronic device and receiving a first electromagnetic wave signal at a first frequency;
a grounding end connected to the common ground end of the electronic device; and
a spread spectrum portion connecting the resonance radiation body and the grounding end, having a first shunting body and a second shunting body, forming an opening between the resonance radiation body and the grounding end by means of the first shunting body and the second shunting body, thereby allowing the first shunting body and the second shunting body to form a loop bypass between the resonance radiation body and the grounding end.

2. The multiband antenna of claim 1, further comprising a feed-in portion and a connection portion which are disposed between the resonance radiation body and the electronic device, the feed-in portion having an end connected to the signal end, and the connection portion having two ends connected to another end of the feed-in portion and the resonance radiation body, respectively.

3. The multiband antenna of claim 2, wherein the connection portion is L-shaped and is of a length equal to one-eighth of a wavelength associated with the first frequency.

4. The multiband antenna of claim 2, wherein the resonance radiation body is of a length equal to one-fourth of a wavelength associated with the first frequency.

5. The multiband antenna of claim 1, wherein the first shunting body and the second shunting body are arranged in an inverted V-shaped configuration between the resonance radiation body and the grounding end.

6. The multiband antenna of claim 5, wherein an end of the first shunting body joins an end of the second shunting body at a side of the resonance radiation body in a manner that a first included angle is formed at the joint between the first shunting body and the second shunting body.

7. The multiband antenna of claim 6, wherein another end of the first shunting body and another end of the second shunting body are connected to a side of the grounding end.

8. The multiband antenna of claim 7, wherein the first shunting body and the second shunting body extend from the joint at the resonance radiation body toward the grounding end in a manner that the first shunting body and the second shunting body each bend by a second included angle after leaving the joint at the resonance radiation body and before reaching the grounding end.

9. The multiband antenna of claim 7, wherein the end of the first shunting body and the end of the second shunting body are connected at the joint at the resonance radiation body in a manner that the first shunting body and the second shunting body extend from the joint at the resonance radiation body toward the grounding end in a manner that the first shunting body and the second shunting body each bend by a second included angle after leaving the joint at the resonance radiation body and before reaching the grounding end such that the other end of the first shunting body and the other end of the second shunting body are located at the grounding end.
